(19) United States
(12) Patent Application Publication
(10) Pub. No.: US 2021/0056586 A1
(43) Pub. Date: Feb. 25, 2021

(54) OPTIMIZING LARGE SCALE DATA ANALYSIS

(71) Applicant: Google LLC, Mountain View, CA (US)

(72) Inventors: Zhaosheng Bao, Mountain View, CA (US); Andreas Ulbrich, Mountain View, CA (US); Jeffrey Wilhelm, Mountain View, CA (US); Evgeny Skvortsov, Kitchener (CA); Yip Man Tsang, Mountain View, CA (US)

(21) Appl. No.: 16/477,437

(22) PCT Filed: Jan. 29, 2019
(86) PCT No.: PCT/US2019/015657

§ 371 Date: Jul. 11, 2019

Related U.S. Application Data
(60) Provisional application No. 62/773,046, filed on Nov. 29, 2018.

(51) Int. Cl. G06Q 30/02; G06F 16/22

(52) U.S. Cl. CPC G06Q 30/0243; G06F 16/2255; G06Q 30/0205

(57) ABSTRACT

Methods, systems, and apparatus, including computer programs encoded on a computer storage medium, for an object grouping system that obtains data for multiple sketches that are each stored using a set of registers and are a sampling of objects in a dataset. Each object in the dataset is a member of a digital audience. For each sketch, the system uses an identifier for a first object to generate a hashed parameter. The system determines whether the hashed parameter contributes to describing demographic attributes of the sampling of objects. The system stores demographic attributes of the first object at a register in the set when it determines that the hashed parameter contributes to describing the demographic attributes. The system generates an output that indicates a number of objects in the digital audience that were reached by content directed at the digital audience and demographic attributes for the number of objects.

### BACKGROUND

This specification relates to computing processes for large-scale similarity calculations.

Analyzing large datasets can be computationally-intensive and obtaining accurate results can cause significant system latency. Sketching techniques can reduce both the computational cost and the latency in obtaining results from analyzing large datasets. Sketching techniques generally involve transforming a large dataset into a mini data set, or sample set, which is representative of particular aspects (or attributes) of the larger dataset. The sample set may be used to obtain a particular data analysis result estimation, such as unique entry counts, within the larger dataset. A sample set can be referred to herein as a sketch data structure or “sketch”. In general, sketches can be useful for estimating the cardinality of unique values for the large dataset.

### SUMMARY

Methods, systems, and apparatus, including computer programs encoded on a computer storage medium, for an object grouping system that obtains data for multiple sketches that are each stored using a set of registers and are a sampling of objects in a dataset. For example, each object in the dataset is an intended recipient of content for a digital audience. For each sketch, the system uses an identifier for a first object to generate a hashed parameter. The system determines whether the hashed parameter contributes to describing demographic attributes of the sampling of objects. The system stores demographic attributes of the first object at a register of the set when it determines that the hashed parameter contributes to describing the demographic attributes. The system generates an output that includes a number of objects in the digital audience that were reached by content (e.g., a digital campaign) directed at the audience and demographic attributes for the number of objects.

One aspect of the subject matter described in this specification can be embodied in a computer-implemented method. The method includes, obtaining, by an object grouping system, data for multiple sketches, wherein each sketch is stored using a set of registers and is a sampling of objects in a dataset, each object in the dataset being a target object for at least one digital campaign. For each sketch of the multiple sketches, the method includes, generating, using an identifier for a first object in the dataset, a hashed parameter for the first object, wherein the hashed parameter has a binary representation; determining, based on the binary representation of the hashed parameter, whether the hashed parameter for the first object contributes to describing demographic attributes of the sampling of objects in the sketch; and in response to determining that the hashed parameter contributes to describing the demographic attributes, storing, at the object grouping system, demographic attributes of the first object at a respective register of a set of registers, wherein each register in the set of registers stores data for a respective object in the sketch. The method also includes, generating, by the object grouping system, a reporting output that indicates: a number of objects in the dataset that were reached by the digital campaign; and demographic attributes about the number of objects in the dataset that were reached by the digital campaign.

These and other implementations can each optionally include one or more of the following features. For example, in some implementations, each object represents a user and generating the reporting output includes: generating a reporting output that describes a number of unique users that were reached by a particular digital campaign and a distribution of one or more unique users, that were reached by the particular digital campaign, across respective demographic categories that are each defined by at least two demographic attributes.

In some implementations, a respective demographic category is defined at least by: a male gender or female gender of a unique user; and an age range of the unique user. In some implementations, determining that the hashed parameter contributes to describing the demographic attributes includes: identifying a number of leading zeros of the hashed parameter, the number of leading zeros being identified from the binary representation of the hashed parameter; and determining, based on the number of leading zeros of the hashed parameter, that the hashed parameter impacts an existing data value stored at the respective register of the set of registers.

In some implementations, determining that the hashed parameter impacts an existing data value stored at the respective register includes: comparing the number of leading zeros in the hashed parameter for the first object to a number of leading zeros in the existing data value stored at the respective register; and based on the comparing, determining that the existing data value stored at the respective register has fewer leading zeros than the number of leading zeros in the hashed parameter.

In some implementations, the hashed parameter comprises at least one of: a hash of the identifier for the first object; or a byte hash for the first object that is based on the identifier for the first object. In some implementations, the hashed parameter for the first object contributes to describing the demographic attributes of the sampling of objects in the sketch when: a number of leading zeros in the binary representation of the hashed parameter exceeds a number of leading zeros in an existing data value stored at the respective register of the set of registers. In some implementations, the hashed parameter contributes to describing the demographic attributes of the sampling of objects in the sketch when: a value of the byte hash for the first object is larger than a value of an existing byte hash stored at the respective register of the set of registers.

In some implementations, storing the demographic attributes for the first object at the respective register includes one or more of: overwriting existing data stored at the respective register of the set of registers; storing the hash of the identifier for the first object; and storing the byte hash for the first object. In some implementations, the demographic attributes for the first object comprises one or more of: age of a user represented by the first object; gender of a user represented by the first object; geographic location of a user represented by the first object; or a real-valued quantity associated with a user represented by the first object.

In some implementations, generating the hashed parameter includes at least one of: generating, using a hashing and demographics module of the object grouping system, a hash of the identifier for the object; or generating, using a hashing and demographics module of the object grouping system, a byte hash based on the identifier for the object. In some implementations, the method further includes: generating, using a hashing and demographics module of the object grouping system, a notification that includes the reporting output, wherein the notification is generated in real-time and indicates demographic attributes about a number of objects that were reached by at least two distinct digital campaigns.

Other implementations of this and other aspects include corresponding systems, apparatus, and computer programs, configured to perform the actions of the methods, encoded on computer storage devices. A computing system of one or more computers or hardware circuits can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

Particular embodiments of the subject matter described in this specification can be implemented so as to realize one or more of the following advantages. The described techniques can enhance standard HyperLogLog (HLL) register libraries so that the registers can be configured to provide corrected breakdowns of certain attributes of objects in a dataset. The described techniques address problems with conventional methods, which may require substantial computing and storage resources, particularly when the underlying dataset is large. The teachings of this document enable generating space-efficient representations of demographic labels for reach reporting that can allow HLL processing and storage requirements to be greatly reduced.

The described techniques provide a streamlined solution to a problem of extending standard HyperLogLog (HLL) to efficiently compute reach and demographic attributes across multiple predefined classes. The predefined classes can be demographic groups for one or more online campaigns that provide content to users in the respective groups. An advantage of the described solution includes enabling efficient computation of demographic data that indicates the number and demographic breakdown of users in a digital audience that were reached by a given campaign without inflating the size of the sketch by a factor of the number of classes that are considered in the breakdown.

Unlike conventional methods that require substantial processing and memory resources, the solution of this document enables practical use of approximate counting for reach and demographic reporting. For example, using the specific computing rules of the solution, counting distribution across at least 10 demographic classes can be performed with improved speed and accuracy and in a manner that would not be practical if performed using the conventional methods. Hence, the techniques of the solution allow for implementing an example reach reporting pipeline that has improved speed and computational power. For example, the computing rules involve using an existing sketch(s) for reporting reach to also encode demographic distribution of objects or users across a certain number of predefined classes, in addition to the number of unique objects in the sketch.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example computing system for computing reach and demographic information for a dataset.

FIG. 2 is a flowchart of an example data engine for computing reach and demographic information for a dataset.

FIG. 3 is a flowchart of an example process for computing reach and demographic information for a dataset.

FIG. 4 is a block diagram of a computing system that can be used in connection with methods described in this specification.

Like reference numbers and designations in the various drawings indicate like elements.

### DETAILED DESCRIPTION

This document describes techniques for enhancing standard HyperLogLog (HLL) register libraries so that the registers can be configured to provide corrected breakdowns of certain attributes of objects in a dataset. For context, standard HLL can be used to measure or estimate reach, which indicates a number of objects in a large dataset that were reached by an online campaign. For example, an online campaign can feature directed electronic content that includes one or more digital components. A digital component can be an active link that directs an object to video clip about an upcoming movie or to a landing page for completing an online transaction.

The size of the data sets typically involved in such applications can often present significant technical challenges in efficiently processing, querying, and storing the data. The estimated reach for the campaign provides an indication of the number of objects in a digital audience that actually received or interacted with the content. In some instances, the online campaign seeks to provide directed content to a group of objects (e.g., users) in a digital audience that have a certain set of demographic characteristics (e.g., age and gender). In other instances, an administrator of multiple campaigns may want to know the respective reach and demographic breakdowns of the number of users that received the content for each of their multiple campaigns. In such instances, conventional methods for computing these breakdowns require substantial computing and storage resources, particularly when the underlying dataset is large and the multiple campaigns are administered across different demographic classes.

The described techniques enhance the standard HLL to also store a sample of various attributes or characteristics of objects or users observed in a dataset. For example, the various attributes can be demographic information for each user in the object, such as a respective age and/or gender of each user. The described techniques enable generating space-efficient representations of demographic labels for reach reporting such that the computing resources for HLL processing and storage and associated costs can be greatly reduced.

For example, to compute accurate demographic breakdowns such as age and gender of a reached audience in a dataset, an object reporting system generates one or more sketches for a digital audience. Each sketch is configured to encode data indicating a distribution of the objects of the dataset across a certain number of demographic classes. The system uses a set of specific computing rules to obtain the distribution of unique objects and to compute a demographic estimation for the number of unique users as well as their distribution across a set of demographic categories (e.g., Male 18-24, Female 18-24, Male 25-35, etc.).

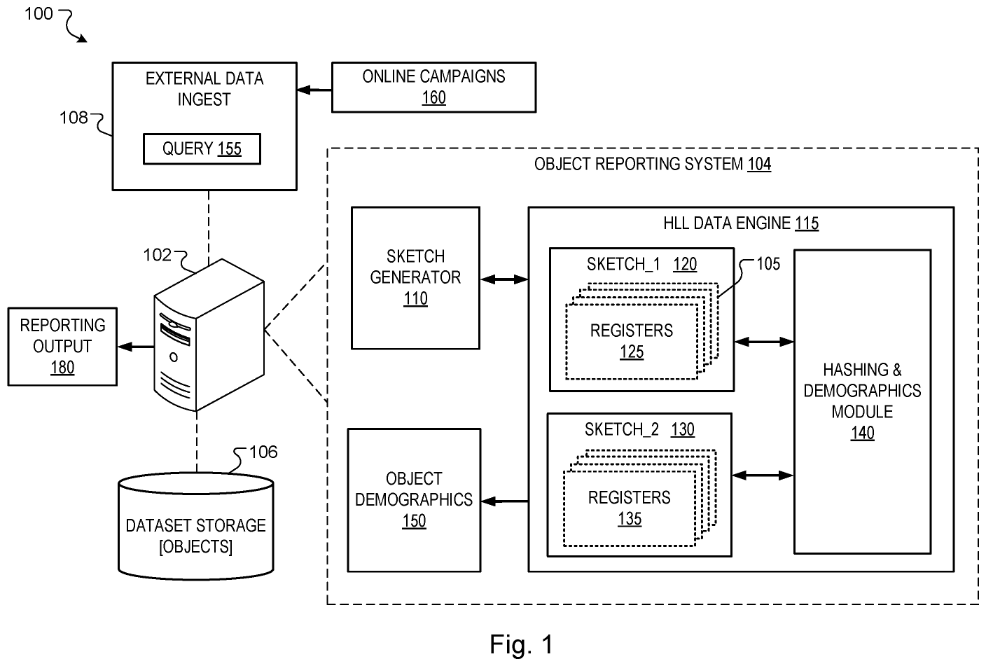

FIG. 1 is a block diagram of an example computing system 100 for computing information for a dataset. System 100 generally includes a computing server 102, an object reporting system 104, a data storage device 106, and a data ingest component 108. As described in more detail below, system 100 includes special-purpose hardware circuitry configured to execute specific computational rules for counting or computing a number of objects in a large dataset and determining a distribution of the objects across a set of predefined data classes.

Execution of these specific rules enables system 100 to compute the number of objects and determine their distribution without having to traverse the large dataset. Specifically, techniques implemented by system 100 can be used to build sketches that encode a distribution of the objects in the dataset across a certain number of demographic classes, in addition to computing a number of unique objects that represent users. The techniques can be applied to online reach and demographic estimation, thus being able to obtain sketches that describe the number of unique users and their distribution across demographic categories, e.g., Male 18-24, Female 18-24, Male 25-35, etc.

Referring now to elements of system 100, computing server 102 is configured to use object reporting system 104 to determine correlations among entities of at least different datasets. In some implementations, object reporting system 104 is included within server 102 as a sub-system of hardware circuits (e.g., special-purpose circuitry) that includes one or more processor microchips. In general, server 102 can include processors (e.g., central or graphics processing units), memory, and data storage devices 106 that collectively form computer systems of server 102. Processors of these computer systems process instructions for execution by server 102, including instructions stored in the memory or on the data storage device 106 to display graphical information for output at an example display monitor of system 100.

In some implementations, execution of the stored instructions cause one or more of the actions described herein to be performed by server 102 or system 104. In other implementations, multiple processors may be used, as appropriate, along with multiple memories and types of memory. For example, server 102 may be connected with multiple other computing devices, with each device (e.g., a server bank, groups of servers, modules, or a multi-processor system) performing portions of the actions, operations, or logical flows described in this specification.

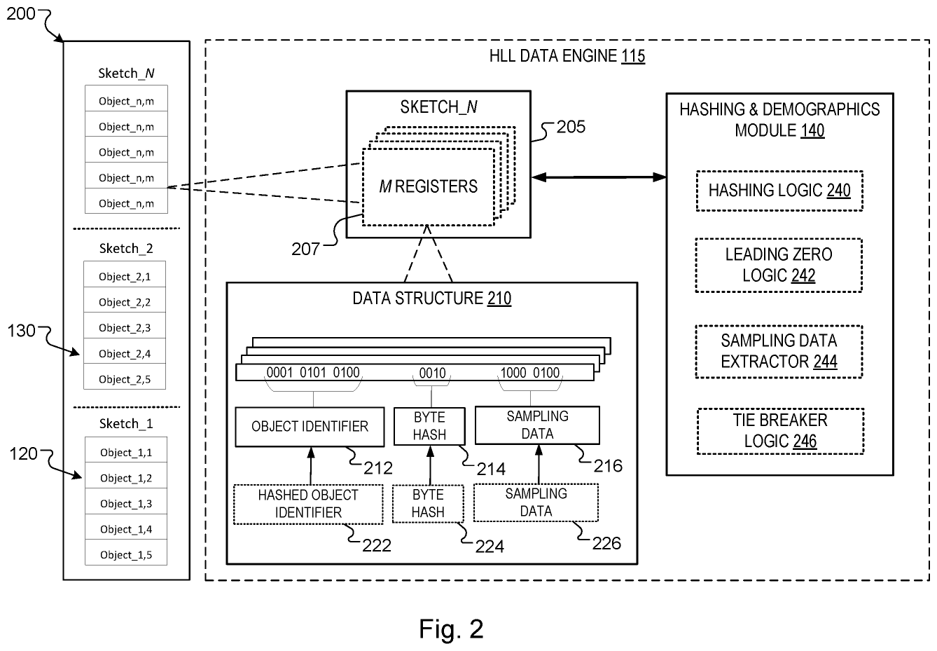

Object reporting system 104 (“system 104”) includes a sketch generator 110 and a HyperLogLog data engine 115 (“HLL engine 115”). HLL engine 115 is discussed briefly with reference to FIG. 1 and is described in more below with reference to FIG. 2. Sketch generator 110 is configured to generate multiple data “sketches” using information stored in data storage device 106. For example, storage device 106 stores large amounts of data including information describing different users that can be represented by a data object of a sketch.

As used in this document, a “sketch” is a data array that describes a set of people or a set of things. For example, a sketch can describe a set of people living in the U.S. or another set of people living in the U.K. Additionally, or alternatively, a sketch can describe a set of persons, user devices, digital assets, or identifiers. For example, a sketch can describe a set of IP addresses that accessed a particular uniform resource locator (URL) (e.g., www.example.com) on a particular day and/or from a particular geographic location.

Each sketch can describe sets of people (or respective objects/object identifiers assigned to people or items) that were recipients of content from a particular online digital campaign 160. For example, a first sketch can include a set of discrete objects that each represent a respective male user that is between 18-years-old to 24-years-old and living in a particular city in the U.K. (e.g., London). This first sketch of male users may have been the target audience of a first digital campaign 160 that provided certain sports, clothing, or entertainment content to one or more user devices of the male users. A second sketch can include a set of discrete objects that each represent a respective female that is between 25-years-old to 30-years-old and living in a particular city in the U.S. (e.g., New York City). This second sketch of female users may have been the target audience of a second different digital campaign 160 that provided certain sports, clothing, or entertainment content to one or more user devices of the female users. In some instances, the first and second sketches include users/members of a digital audience that are an off-target audience. The off-target audience represents a set of users in a digital audience that are not the intended recipient of certain directed content.

The first and second sketches may be respective data samples that are representative of characteristics possessed by a larger dataset of users. The larger data set can include males and females, of varying age ranges, and that were target audience of multiple different digital campaigns that each provide different types of digital content to users. In some implementations, the digital campaigns 160 include online content (e.g., a sponsored content item) that may be clicked or interacted with by a user to arrive at a landing page that hosts commercial products that can be procured by the user. In other implementations, digital campaigns 160 can be refereed to alternatively as digital audience 160 and represents a group of users that are the intended recipient of certain directed content. The directed content can include data and other information that is not associated with a digital campaign.

In some implementations, the sketches are generated for storage in an example memory 105 of system 104 based on analysis and information sorting performed on datasets obtained from storage device 106. The memory 105 of system 104 can include a variety of sketches that are grouped, or otherwise characterized, by information type. For example, the memory 105 of system 104 can include sketches of pre-sorted object data that correspond to different types of users (e.g., human users or user devices), including information pertaining to user demographics for different geographic regions, domain names, commercial products, or various digital and real-world items or objects.

As described herein, each sketch stored in the memory 105 of system 104 includes a set of objects. Each object in the set of objects can correspond to a respective user, and each object can be identified by a unique object identifier (described below). A respective sketch can be a dataset that is derived or generated using conventional or standard HLL methods. Such methods include HLL engine 115 allocating a particular number of registers 125, 135 for each sketch generated by sketch generator 110.

In general, each sketch is stored using a set of M registers 125 and is generated based on a large set of information, e.g., about users online, stored in storage device 106. For example, each sketch is a sampling of objects in a large dataset that includes information about multiple users (e.g., thousands or millions of users). In some implementations, a size of a sketch is proportional to M and virtually doesn't increase with the growth of user data stored in the large dataset. The sketch may have an approximation error and the larger the parameter value of M, the smaller the approximation error will be.

The sketches can be generated in response to processors of system 104 executing an HLL sketching algorithm or related adaptive sampling algorithm to process user data loaded at a GPU of system 104. The HLL sketching algorithm is an algorithm used to perform approximate counting, which allows for creating sketches of large sets of objects. In some cases, a sketch is referred to as an HLL instance and registers 125, 135 can be referred to as HLL registers.

HLL engine 115 can be configured to allocate M registers for a respective sketch, where M is an example parameter (e.g., an integer value). For approximate counting using HLL methods, each register 125, 135 stores data for an object that corresponds to a human user. For example, each register stores the unique object identifier for a respective object that corresponds to a human user in a sketch. The object identifier can have a binary representation. Storing the object identifier in a register 125 includes storing the binary representation in the register as the data for the object that corresponds to the human user. In the example of FIG. 1, a first sketch 120 uses registers 125 to store data for each object in the first sketch 120, while a second sketch 130 uses registers 135 to store data for each object in the second sketch 130.

As discussed in more detail below, the HLL data engine 115 uses hashing and demographics module 140 to implement one or more techniques for enhancing standard HLL register libraries so that the registers 125, 135 can be used or configured to provide corrected breakdowns of certain attributes of objects in respective sketches 120, 130. For example, system 104 is configured to provide breakdowns of attributes such as object or user demographics across multiple sketches and for sketches that correspond to specific online campaigns 160.

The breakdown of user demographics corresponds to object demographics 150. Based on the described techniques, object demographics 150 provides a more space-efficient representation of demographic labels for users of a digital campaign. This space-efficient representation requires a reduced (e.g., substantially reduced) amount of memory or storage resources relative to the resources required for the standard HLL method.

System 100 can receive, via data ingest 108, data describing user or user device interactions with certain digital components of an online campaign 160. For example, the data may indicate which set of users clicked on or interacted with a certain directed content embodied by a digital component of an online campaign. Received data about user activity with the content of an online campaign 160 is stored at storage device 106. This data is obtained by system 104 and used to generate sketches that provide a representative sampling of users that were reached by one or more online campaigns 160.

Data ingest 108 is used by system 100 to receive user queries 155. For example, a query 155 can request information that identifies demographic breakdowns of the number of users that were reached by content of an online campaign 160 or that interacted with the content of the online campaign 160. In response to processing the query 155 using the enhanced HLL techniques of this document, object reporting system 104 generates object demographics 150. Object demographics 150 identifies demographic breakdowns (e.g., males, 18-24 years old, in U.K.) of the number of users that were reached by content of a particular online campaign 160.

FIG. 2 is a more detailed diagram of the HLL data engine 115 used in combination with components of system 100 to compute reach and demographic information for a large dataset of users.

System 100 is configured to compute accurate demographic breakdowns such as age and gender of reached user audiences that are represented by objects in a large dataset. To compute the breakdowns, HLL engine 115 is used to generate sketches that encode data that can indicate a distribution of the objects of a large dataset across a certain number of demographic classes. In some implementations, the HLL engine 115 computes the demographic breakdowns as a later process that is based on an initial determination that a first object contributes to describing demographic attributes of the sampling of objects in sketch 205.

As noted above, each object can be identified by a unique object identifier 212. The object identifier can have a binary representation (e.g., 0001 0101 0100). In some implementations, the object identifier is a byte (e.g., four bits), while in other implementations the object identifier is a data word formed by eight bits, 12 bits, 16 bits, 32 bits, or 64 bits. In some cases, a variable number of bits can be used to form the object identifier, such as more than 64 bits or fewer than 64 bits.

In one example implementation, the object identifier can be a 12-bit data word that has a particular number of leading zeros. In some cases, a data value of the 12-bit data word, or the number leading zeros of the data word, can be used to characterize the object identifier 212. For example, the decimal value (e.g., the data value) of the object identifier 212 or the number of leading zeros can indicate a size or magnitude of the object identifier.

As shown at FIG. 2, a data structure 210 includes distinct items of data that represent an object (e.g., a user) stored at a register 207 of a set of registers that store sketch 205. In particular, the distinct items of data in the data structure 210 include object identifier 210, a byte hash 214, and sampling data 216. The byte hash 214 is based on the object identifier 212 and the sampling data 216 indicates demographic attributes of a user represented by the data object. Relative to standard HLL methods, the byte hash 214 and the sampling data 216 represent additional information stored at respective HLL registers for enhancing the standard HLL methods to more efficiently compute demographic breakdowns of a large set of users.

In general, a byte hash can be an extra byte-sized hash of the object and may be derived from a portion of the data word that represents the object identifier. The sampling data 216 can indicate real-valued quantities, such as an estimated income of the user, e.g., in dollars and cents. The data items of data structure 210 can represent existing data stored at register 207. As discussed below, this existing data may later be overwritten based on the described techniques for generating a space-efficient representation of demographic information about a set of users.

HLL engine 115 obtains data for a first object to compute demographic breakdowns such as age and gender of reached user audiences represented by objects in a large dataset. The first object can be assigned to a particular register, e.g., register 207, in a set of M registers for a sketch 205 stored in a memory of the HLL data engine 115. The obtained first object can be assigned to register 207 in the set of registers based on stochastic distribution.

The HLL engine 115 generates one or more hashed parameters using the hashing and demographics module 140. For example, hashing logic 240 is executed to generate the hashed parameter based on a particular hash function invoked by the hashing logic 240. Generating the one or more hashed parameters includes at least one of: i) using the hashing and demographics module 140 to generate a hash of the object identifier 222 for the first object or ii) using the hashing and demographics module 140 to generate a byte hash 224 based on the object identifier for the first object. The hash of the object identifier for the obtained first object is indicated as hashed object identifier 222 in the implementation of FIG. 2.

In some implementations, the hashing and demographics module 140 generates a first hashed parameter 222 that is a hash of the object identifier for the first object and generates a second hashed parameter 224 that is a byte hash derived from the object identifier for the first object. As indicated at FIG. 2, the respective first and second hashed parameters 222, 224 can be included in the example data structure 210, e.g., in response to overwriting the existing data of the data structure 210.

The HLL engine 115 uses at least one hashed parameter, as well as other processes and parameters, to determine whether the first object contributes to describing demographic attributes of objects in sketch 205, where the sketch 205 is an approximate count that is representative of a larger user audience. To make this determination about the first object, the hashing and demographics module 140 determines whether the hashed parameter 222 impacts an existing data value stored at the respective register 207 of the set of registers for sketch 205. To determine that the hashed parameter 222 impacts an existing data value stored at the register 207, the HLL engine 115 uses the hashing and demographics module 140 to compare the hashed parameter 222 to data for a current object stored in register 207.

For example, the hashed parameter 222 is compared to existing object identifier 212 stored at register 207. To perform the comparison, the hashing and demographics module 140 uses leading zero logic 242 to determine a number of leading zeros of the object identifier 212 and to determine the number of leading zeros of the generated hashed parameter 222. For example, the hashing and demographics module 140 can use logic 242 to analyze an existing object identifier 212 of data structure 210 against the hashed object identifier 222. The number of leading zeros is identified from the respective binary representation of the object identifier 212 and hashed parameter 222.

Based on the preceding comparison, the hashed parameter 222 impacts an existing data value stored at register 207 if the number of leading zeros of the hashed parameter 222 is large enough to impact the number of leading zeros (e.g., that corresponds to the data value) of the current object identifier 212 stored at the register. For example, if the binary representation of the hashed parameter 222 has a greater number of leading zeros than the binary representation of the existing object identifier 212, then the HLL engine 115 determines that the hashed parameter 222 impacts an existing data value stored at the register 207.

In response to determining that the hashed parameter 222 impacts an existing data value stored at the register 207, the HLL engine 115 will update the existing byte hash 214 and the sampling data 216 by overwriting these data items with the byte hash 224 and the sampling data 226 of the first object, respectively. For example, a sampling data extractor 244 can identify sampling data of the first object that corresponds to demographic attributes or other real-valued quantities. The sampling data extractor 244 obtains or extracts the identified demographic attributes or real-value quantities of the first object to form sampling data 226. The sampling data 226 that is used to overwrite the existing sampling data of the register 207 can include additional demographic information that contributes providing a more accurate demographic breakdown of the large audience represented by the sketch 205.

After data for the first object is used to overwrite data for an existing object stored at register 207, the first object then becomes the existing object, and the described methods can extend to a data for a second different object. In some implementations, a current hashed object identifier 222, hashedOI_old, for a first object is compared to a newly generated hashed object identifier, hashedOI_new, for a second object. The parameter hashedOI_old may represent a hashed object identifier 222 that was used to overwrite data for a prior existing object identifier 212, while the parameter hashedOI_new may represent a new hashed object identifier that can be used to overwrite data for a prior existing hashed object identifier 222. In this manner, a second object may have sampling data that further contributes to providing a more accurate demographic breakdown of the larger audience represented by the sketch 205.

In some implementations, the number of leading zeros of the hashed parameter 222 may be the same as the number of leading zeros of the current object identifier 212 stored at the register 207 or may not be large enough to impact the number of leading zeros of the current object identifier 212 stored at the register. For these implementations, the hashing and demographics module 140 uses tie breaker logic 246 to determine whether the hashed parameter 222 contributes to describing demographic attributes of the sampling of objects in the sketch 205.

For example, using tie breaker logic 246, the hashed parameter 222 contributes to describing the demographic attributes of objects in the sketch when a value of the byte hash 224 is larger than a value of the existing byte hash 214 stored at the register 207. If tie breaker logic 246 computes that the value of the byte hash 224 is larger than the value of the existing byte hash 214, then HLL engine 115 stores the data for the first object in the register 207, where the stored data includes demographic attributes for the first object. In some implementations, storing the data for the first object includes the HLL engine 115 storing the trailing 8 bits of the hashed object identifier 222 in the register 207 as byte hash 224.

In some examples, the number of leading zeros of the hashed parameter 222 may be the same as the number of leading zeros of the current object identifier 212 stored at the register 207 or may not be large enough to impact the data value of the current object identifier 212 stored at the register 207. Additionally, the value of the byte hash 224 may also be equal to the value of the existing byte hash 214. In these examples, the HLL engine 115 uses a preconfigured demographic setting of the register 207. For example, each register 207 in a set of M registers that stores respective objects of sketch 205 can each have a preconfigured demographic setting. This setting defines a preferred demographic attribute.

For example, each register will have a preference of demographic attributes, such as particular ages and a particular gender. The demographic settings can be random from register to register. Hence, if HLL engine 115 determines that there is a tie in the number of leading zeros of the existing object identifier and a hashed object identifier and that the respective byte hashes of the existing object identifier and the hashed object identifier are equal, then sampling data extractor 244 references the settings for register 207 to extract and store certain sampling data of the first object at the register 207. The extracted sampling data will include demographic attributes of the first object that align with the preconfigured demographic settings of the register 207. In this manner, tie breaker logic 246 can be used to create a randomized, deterministic ordering across all users or objects that have the same number of leading zeros in a register for a sketch.

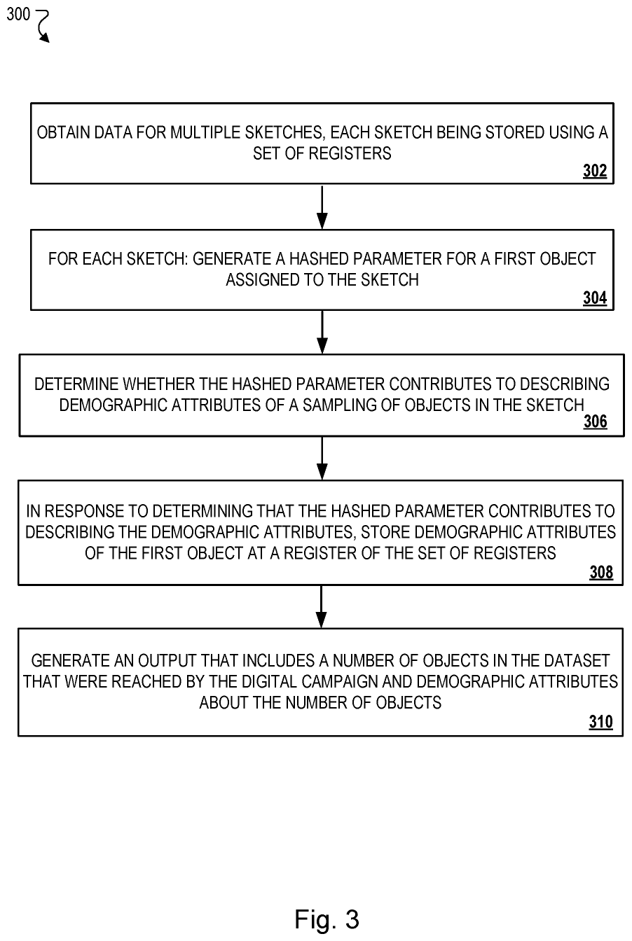

FIG. 3 is a flowchart of an example process 300 for computing reach and demographic information for a dataset. Process 300 can be implemented or executed using system 100 described above and descriptions of process 300 may reference the above-mentioned computing resources of system 100. In some implementations, described actions of process 300 are enabled by programmed instructions executable by at least one processor and memory of computing systems described in this document.

Referring now to process 300, system 100 obtains data for multiple sketches (302). For example, object grouping system 104 obtains data for multiple sketches, where each sketch is stored using a set of registers 125, 135 at system 104. In some implementations, sketch generator 110 of system 104 obtains data from data storage device 106 and generates multiple pre-sorted data arrays (e.g., sketches) that each include a predetermined quantity of objects. In some implementations, pre-sorting the data and generating the sketches can occur in response to processors of system 104 executing an example sketch algorithm to process the obtained data.

Sketch generator 110 of system 104 can be configured to obtain data from data storage device 106, pre-sort the data, and generate multiple pre-sorted data arrays (e.g., sketches) that each include a predetermined quantity of objects. In some implementations, pre-sorting the data and generating the sketches can occur in response to processors of system 104 executing an example sketch algorithm to process the obtained data. For example, generating the sketches can occur in response to processors executing a k-min-hash or k-minimum value (“KMV”) data processing algorithm to sort data that is pre-loaded at a GPU of system 104.

The generated sketches each have a predefined data size. For example, the predefined data size can be set such that each sketch includes no more than 22,000 or 64,000 (“64 k”) objects. In some implementations, the data size can be less than 22 k objects or more than 64 k, but less than a particular quantity of objects that would exceed a certain memory or total register capacity of HLL engine 115. In other implementations, the predefined data size of the sketches is set based on a cache memory capacity of the HLL engine 115.

The sketches can be a sampling of objects in a large dataset of storage device 106 and each sketch corresponds to respective sets of objects that represent users. Objects of a sketch can be items, persons, or various electronic devices. For example, objects of one sketch can be persons or users of a particular demographic (e.g., males in their 20's) that reside in a certain geographic region (e.g., the United Kingdom (U.K.)). Similarly, objects of another sketch can be users of another demographic (e.g., the general population) that also reside in the same geographic region. Each object in the dataset can be a target user for at least one digital campaign.

For each sketch, system 104 generates a hashed parameter for a first object (304). The hashed parameter has a binary representation based on zeros and ones. The HLL data engine 115 uses hashing and demographics module 140 to generate the hashed parameter. For example, the hashing logic 240 is executed to generate the hashed parameter based on a particular hash function invoked by logic 240. The hash function generates the hashed parameter using an object identifier for the first object, e.g., a 12-bit object identifier. Hashing and demographics module 140 is used to determine whether the hashed parameter contributes to describing demographic attributes of the sampling of objects in the sketch (306).

For example, the hashed parameter 222 contributes to describing demographic attributes of a sampling of objects in sketch 205 if the hashed parameter 222 impacts an existing data value stored at respective register 207. In some implementations, the hashed parameter 222 impacts the existing data value when a number of leading zeros in a binary representation of the hashed parameter 222 exceeds a number of leading zeros that define an existing data value stored at the register 207. Stated another way, HLL engine 115 can count the number of leading zeros of an integer value of the binary representation of a hash of the object identifier for a newly obtained user, e.g., that is distinct from an existing user stored at register 207. This new user can have demographic attributes that potentially can contribute to more accurately characterizing an overall estimated demographic composition of a larger audience that includes the new user.

For example, for a given person (e.g., a first object/new user), an integer value of a user ID or object identifier for the person is hashed using hashing logic 240. Leading zero logic 242 then counts the number of leading zeros in the binary form of the hashed integer value. Hashing and demographic module 140 reads the integer value or hashed integer value for an existing person stored in the register 207 that this new person will potentially contribute to. When the number of leading zeros for a hash of the identifier for the new person is the same as that of the existing person, then tie breaker logic 246 can apply the preceding process to the respective byte hash for the newly obtained user and the byte hash for the existing user stored at the register 207.

If the number of leading zeros that corresponds to the hashed integer value for the new person is larger than the number of leading zeros that corresponds to a hashed integer value for existing person, then the hashed integer value for the new person is used to overwrite or replace the hashed integer value for existing person stored at the register 207. For example, sampling data extractor 244 uses sampling data (e.g., demographic information) for the new person to replace the demographic information of the existing person stored at the register. Alternatively, if the hashed integer value for the new person is smaller than the hash integer value for the existing person, then this new person or user has no contribution to capturing, refining, or further improving accuracy of the demographic estimates of the sketch.

In response to determining that the hashed parameter contributes to describing the demographic attributes, the hashing and demographics module 140 is used to store demographic attributes of the first object at a register of the set of registers (308). This storing operation can correspond to HLL engine 115 replacing or overwriting the hashed integer value (e.g., demographic information) for an existing person or user with demographic information for a new person/user. In some implementations, storing the demographic attributes for the first object at the respective register 207 includes one or more of: overwriting existing data stored at the respective register 207 of the set of M registers; storing the hash of an identifier for the first object (e.g., a hashed integer value); and storing the byte hash for the first object.

In some implementations, prior to storing, demographic attributes can be “collapsed” or compressed to minimize memory or disk space usage in the registers for a sketch. For example, HLL engine 115 can execute a collapse function to convert data describing demographic information to a collapsed version of the data. This can allow for an even more efficient use of memory resources or registers that are used to store demographic attributes for a sketch. For example, to reduce memory/disk usage, HLL engine 15 can store a collapsed demographic information at register 207. This enables demographic data encoding into a uint64, which reduces (e.g., substantially reduces) memory or register space requirements relative to a non-collapsed version of demographic information for a user. The collapse function generates collapsed demographic data that provides a probabilistic version of the full demographic distribution.

System 104 generates a reporting output that provides a number of objects in the dataset that were reached by the digital campaign and demographic attributes about the number of objects (310). For example, system 100 receives query 155 seeking information about which targeted content of a particular digital campaign reached 20-year-old males in the U.K. In some implementations, the reporting output provides a measure of effectiveness of a digital campaign for a particular audience demographic. For example, the reporting output can indicate which content was found to be more interesting to a group of male or female users in the U.K., relative to the general population in the U.K. In some implementations, the measure of effectiveness indicates: a number of objects in the dataset that were reached by the digital campaign and demographic attributes about the number of objects in the dataset that were reached by the digital campaign.

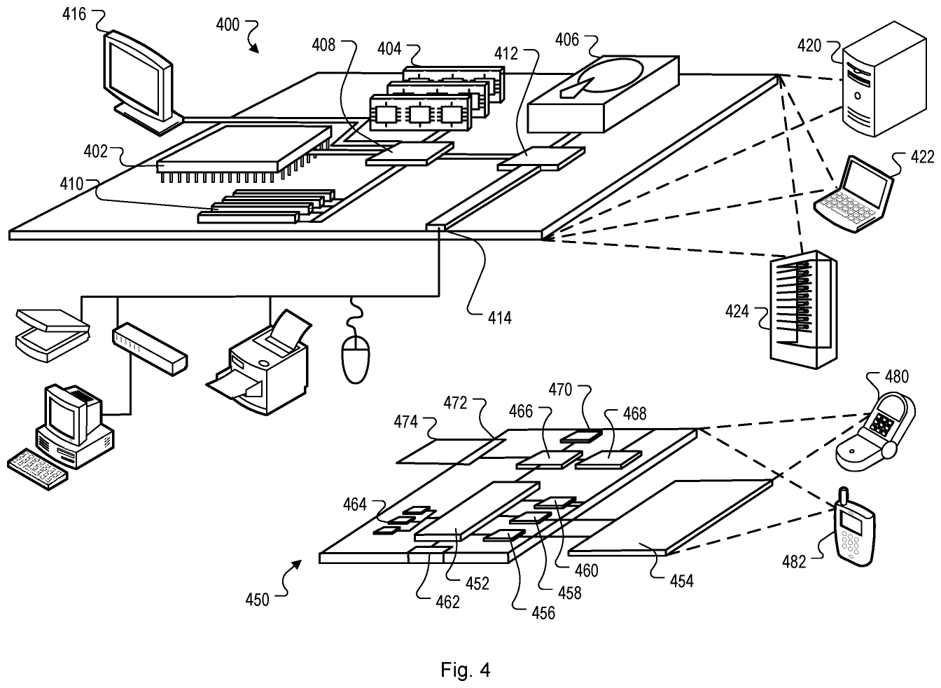

FIG. 4 is a block diagram of computing devices 400, 450 that may be used to implement the systems and methods described in this document, either as a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low speed controller 412 manages lower bandwidth-intensive operations. Such allocation of duties is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provided as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component such as an application server, or that includes a front end component such as a client computer having a graphical user interface or a Web browser through which a user can interact with an implementation of the systems and techniques described here, or any combination of such back end, middleware, or front end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

As used in this specification, the term “module” is intended to include, but is not limited to, one or more computers configured to execute one or more software programs that include program code that causes a processing unit(s)/device(s) of the computer to execute one or more functions. The term “computer” is intended to include any data processing or computing devices/systems, such as a desktop computer, a laptop computer, a mainframe computer, a personal digital assistant, a server, a handheld device, a smartphone, a tablet computer, an electronic reader, or any other electronic device able to process data.

A number of embodiments have been described. Nevertheless, it will be understood that various modifications may be made without departing from the spirit and scope of the invention. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method, comprising:
obtaining, by an object grouping system, data for a plurality of sketches, wherein each sketch is stored using a set of registers and is a sampling of objects in a dataset, each object in the dataset being a target object for at least one digital campaign;
for each sketch of the plurality of sketches:
generating, using an identifier for a first object in the dataset, a hashed parameter for the first object, wherein the hashed parameter has a binary representation;
determining, based on the binary representation of the hashed parameter, whether the hashed parameter for the first object contributes to describing demographic attributes of the sampling of objects in the sketch; and
in response to determining that the hashed parameter contributes to describing the demographic attributes, storing, at the object grouping system, demographic attributes of the first object at a respective register of a set of registers, wherein each register in the set of registers stores data for a respective object in the sketch; and
generating, by the object grouping system, a reporting output that indicates:
a number of objects in the dataset that were reached by the digital campaign; and
demographic attributes about the number of objects in the dataset that were reached by the digital campaign.

2. The method of claim 1, wherein each object represents a user and generating the reporting output comprises:
generating a reporting output that describes a number of unique users that were reached by a particular digital campaign and a distribution of one or more unique users, that were reached by the particular digital campaign, across respective demographic categories that are each defined by at least two demographic attributes.

3. The method of claim 2, wherein a respective demographic category is defined at least by:
a male gender or female gender of a unique user; and
an age range of the unique user.

4. The method of claim 1, wherein determining that the hashed parameter contributes to describing the demographic attributes comprises:
identifying a number of leading zeros of the hashed parameter, the number of leading zeros being identified from the binary representation of the hashed parameter; and
determining, based on the number of leading zeros of the hashed parameter, that the hashed parameter impacts an existing data value stored at the respective register of the set of registers.

5. The method of claim 4, wherein determining that the hashed parameter impacts an existing data value stored at the respective register comprises:
comparing the number of leading zeros in the hashed parameter for the first object to a number of leading zeros in the existing data value stored at the respective register; and
based on the comparing, determining that the existing data value stored at the respective register has fewer leading zeros than the number of leading zeros in the hashed parameter.

6. The method of claim 1, wherein the hashed parameter comprises at least one of:
a hash of the identifier for the first object; or
a byte hash for the first object that is based on the identifier for the first object.

7. The method of claim 6, wherein the hashed parameter for the first object contributes to describing the demographic attributes of the sampling of objects in the sketch when:
a number of leading zeros in the binary representation of the hashed parameter exceeds a number of leading zeros in an existing data value stored at the respective register of the set of registers.

8. The method of claim 6, wherein the hashed parameter contributes to describing the demographic attributes of the sampling of objects in the sketch when:
a value of the byte hash for the first object is larger than a value of an existing byte hash stored at the respective register of the set of registers.

9. The method of claim 6, wherein storing the demographic attributes for the first object at the respective register comprises one or more of:
overwriting existing data stored at the respective register of the set of registers;
storing the hash of the identifier for the first object; and
storing the byte hash for the first object.

10. The method of claim 9, wherein the demographic attributes for the first object comprises one or more of:
age of a user represented by the first object;
gender of a user represented by the first object;
geographic location of a user represented by the first object; or
a real-valued quantity associated with a user represented by the first object.

11. The method of claim 1, wherein generating the hashed parameter comprises at least one of:
generating, using a hashing and demographics module of the object grouping system, a hash of the identifier for the object; or
generating, using a hashing and demographics module of the object grouping system, a byte hash based on the identifier for the object.

12. The method of claim 1, further comprising:
generating, using a hashing and demographics module of the object grouping system, a notification that includes the reporting output, wherein the notification is generated in real-time and indicates demographic attributes about a number of objects that were reached by at least two distinct digital campaigns.

13. A system comprising:
one or more processing devices; and
one or more non-transitory machine-readable storage devices storing instructions that are executable by the one or more processing devices to cause performance of operations comprising:
obtaining, by an object grouping system, data for a plurality of sketches, wherein each sketch is stored using a set of registers and is a sampling of objects in a dataset, each object in the dataset being a target object for at least one digital campaign;
for each sketch of the plurality of sketches:
generating, using an identifier for a first object in the dataset, a hashed parameter for the first object, wherein the hashed parameter has a binary representation;
determining, based on the binary representation of the hashed parameter, whether the hashed parameter for the first object contributes to describing demographic attributes of the sampling of objects in the sketch; and
in response to determining that the hashed parameter contributes to describing the demographic attributes, storing, at the object grouping system, demographic attributes of the first object at a respective register of a set of registers, wherein each register in the set of registers stores data for a respective object in the sketch; and
generating, by the object grouping system, a reporting output that indicates:
a number of objects in the dataset that were reached by the digital campaign; and
demographic attributes about the number of objects in the dataset that were reached by the digital campaign.

14. The system of claim 13, wherein each object represents a user and generating the reporting output comprises:
generating a reporting output that describes a number of unique users that were reached by a particular digital campaign and a distribution of one or more unique users, that were reached by the particular digital campaign, across respective demographic categories that are each defined by at least two demographic attributes.

15. The system of claim 13, wherein determining that the hashed parameter contributes to describing the demographic attributes comprises:
identifying a number of leading zeros of the hashed parameter, the number of leading zeros being identified from the binary representation of the hashed parameter; and
determining, based on the number of leading zeros of the hashed parameter, that the hashed parameter impacts an existing data value stored at the respective register of the set of registers.

16. The system of claim 15, wherein determining that the hashed parameter impacts an existing data value stored at the respective register comprises:
comparing the number of leading zeros in the hashed parameter for the first object to a number of leading zeros in the existing data value stored at the respective register; and
based on the comparing, determining that the existing data value stored at the respective register has fewer leading zeros than the number of leading zeros in the hashed parameter.

17. The system of claim 13, wherein the hashed parameter comprises at least one of:
a hash of the identifier for the first object; or
a byte hash for the first object that is based on the identifier for the first object.

18. The system of claim 17, wherein the hashed parameter for the first object contributes to describing the demographic attributes of the sampling of objects in the sketch when:
a number of leading zeros in the binary representation of the hashed parameter exceeds a number of leading zeros in an existing data value stored at the respective register of the set of registers.

19. The system of claim 17, wherein the hashed parameter contributes to describing the demographic attributes of the sampling of objects in the sketch when:
a value of the byte hash for the first object is larger than a value of an existing byte hash stored at the respective register of the set of registers.

20. The system of claim 17, wherein storing the demographic attributes for the first object at the respective register comprises one or more of:
overwriting existing data stored at the respective register of the set of registers;
storing the hash of the identifier for the first object; and
storing the byte hash for the first object.

21. The system of claim 20, wherein the demographic attributes for the first object comprises one or more of:
age of a user represented by the first object;
gender of a user represented by the first object;
geographic location of a user represented by the first object; or
a real-valued quantity associated with a user represented by the first object.

22. The system of claim 13, wherein the operations further comprise:
generating, using a hashing and demographics module of the object grouping system, a notification that includes the reporting output, wherein the notification is generate in real-time and indicates demographic attributes about a number of objects that were reached by at least two distinct digital campaigns.

23. One or more non-transitory machine-readable storage devices storing instructions that are executable by one or more processing devices to cause performance of operations comprising:
obtaining, by an object grouping system, data for a plurality of sketches, wherein each sketch is stored using a set of registers and is a sampling of objects in a dataset, each object in the dataset being a target object for at least one digital campaign;
for each sketch of the plurality of sketches:
generating, using an identifier for a first object in the dataset, a hashed parameter for the first object, wherein the hashed parameter has a binary representation;
determining, based on the binary representation of the hashed parameter, whether the hashed parameter for the first object contributes to describing demographic attributes of the sampling of objects in the sketch; and
in response to determining that the hashed parameter contributes to describing the demographic attributes, storing, at the object grouping system, demographic attributes of the first object at a respective register of a set of registers, wherein each register in the set of registers stores data for a respective object in the sketch; and
generating, by the object grouping system, a reporting output that indicates:
a number of objects in the dataset that were reached by the digital campaign; and
demographic attributes about the number of objects in the dataset that were reached by the digital campaign.
